(19) United States
(12) Patent Application Publication
(10) Pub. No.: US 2017/0164079 A1
(43) Pub. Date: Jun. 8, 2017

(54) SOUNDBOX

(71) Applicants: LE HOLDINGS (BEIJING) CO., LTD., Beijing (CN); LE SHI ZHI XIN ELECTRONIC TECHNOLOGY (TIANJIN) LIMITED, Beijing (CN)

(72) Inventor: Chuanfeng XU, Beijing (CN)

(21) Appl. No.: 15/242,181

(22) Filed: Aug. 19, 2016

Related U.S. Application Data
(63) Continuation of application No. PCT/CN2016/088461, filed on Jul. 4, 2016.

(30) Foreign Application Priority Data
Dec. 4, 2015 (CN) 2015209998028

(51) Int. Cl. H04R 1/02; H04R 1/26; H04R 1/32

(52) U.S. Cl. CPC H04R 1/025; H04R 1/323; H04R 1/26

(57) ABSTRACT

A loudspeaker is disclosed, wherein the loudspeaker comprises a loudspeaker main body; the loudspeaker main body is provided with a first surface and a second surface which are perpendicular to each other; the first surface is provided with a first speaker unit; the second surface is provided with a second speaker unit. In the loudspeaker according to the present disclosure, the loudspeaker main body is provided with a first surface and a second surface which are perpendicular to each other, the first speaker unit is disposed on the first surface, and the second speaker unit is disposed on the second surface.

### CROSS REFERENCE TO RELATED APPLICATIONS

The present application is a continuation of PCT application which has an application number of PCT/CN2016/088461 and was filed on Jul. 4, 2016. This application is based upon and claims priority to Chinese Patent Application NO. 201520999802.8, titled “loudspeaker”, filed on Dec. 4, 2015 with the Chinese Patent Office, the entire contents of which are incorporated herein by reference.

### TECHNICAL FIELD

The disclosure relates to the technical field of acoustic energy conversion, particularly to a loudspeaker, and more specifically to a loudspeaker having a small size and a good stereo acoustic effect.

### BACKGROUND

As people's living standard rises and TV image level develops swiftly, people have an increasingly high pursuit for TV sound; meanwhile, development of ultrathin TV sets greatly limit improvement in respect of TV set sound, and even TV set sound gets worse and worse. Therefore, a loudspeaker product with an independent sound system occurs. Upon use, the loudspeaker is placed horizontally before the TV set. The loudspeaker comprises a low frequency speaker unit, a high frequency speaker unit and a medium frequency speaker unit; or comprises a low frequency speaker unit and a full frequency speaker unit.

During implementation of the instant invention, the Inventor finds that there are at least the following problems with the prior art: due to requirements of the sound system, the low frequency speaker unit has a relatively large size; if the low frequency speakers are all placed towards forward, namely, towards the user, an overall height of the loudspeaker will be made relatively high. Furthermore, since the loudspeaker is high, when the loudspeaker is placed in front of a TV set with a lower stand, it might shield a TV set remote control receiver and even shield the TV images, thereby reducing the user's experience.

### SUMMARY

In view of the above problem, the present disclosure is proposed to provide a loudspeaker which overcomes the above problems or at least partially solves the above problems.

According to an aspect of the present application, there is provided a loudspeaker. The loudspeaker comprises a loudspeaker main body,

The loudspeaker main body is provided with a first surface and a second surface which are perpendicular to each other;

The first surface is provided with a first speaker unit;

The second surface is provided with a second speaker unit.

The Inventor of the present disclosure finds that in the prior art, speaker units are all disposed on the same surface of the loudspeaker main body and make the size of the loudspeaker larger. Hence, a technical task to be accomplished or a technical problem to be solved in the present disclosure is never envisaged or anticipated by those skilled in the art, so the present disclosure is a new technical solution.

### BRIEF DESCRIPTION OF THE DRAWINGS

Various other advantages and merits will be made apparent to those having ordinary skill in the art by reading through detailed description of preferred embodiments below. Figures are only used to illustrate preferred embodiments and cannot be construed as limiting the present application. Throughout the figures, identical reference numbers denote identical parts. Among the figures:

FIG. 1 is a structural view of a loudspeaker according to some embodiments of the present disclosure;

FIG. 2 is a structural view of some embodiments of the present disclosure.

In the figures, the reference number 1 denotes a main body; number 2 denotes a low frequency speaker unit, number 3 denotes a full frequency speaker unit; number 4 denotes a medium frequency speaker unit; 5 a high frequency speaker unit.

### DETAILED DESCRIPTION

Exemplary embodiments of the present disclosure will be described in more detail below with reference to figures. Although the figures show exemplary embodiments of the present disclosure, it should be appreciated that the present disclosure may be implemented in various forms and should not be limited by embodiments illustrated here. On the contrary, these embodiments are provided to enable more thorough understanding of the present disclosure, and completely convey the scope of the present disclosure to those skilled in the art.

An embodiment of the present disclosure provides a loudspeaker. A loudspeaker main body 1 is provided with a first surface and a second surface which are perpendicular to each other, wherein the first surface is provided with a first speaker unit; the second surface is provided with a second speaker unit. The first speaker unit may be a low frequency speaker unit, a medium frequency speaker unit, a high frequency speaker unit or a full frequency speaker unit, or may be a combination of many types of speaker units. Likewise, the second speaker unit may be a low frequency speaker unit, a medium frequency speaker unit, a high frequency speaker unit or a full frequency speaker unit, or may be a combination of many types of speaker units. Arrangement of the speaker units is not limited in the present disclosure so long as it can meet requirements of sound effect matching and use size.

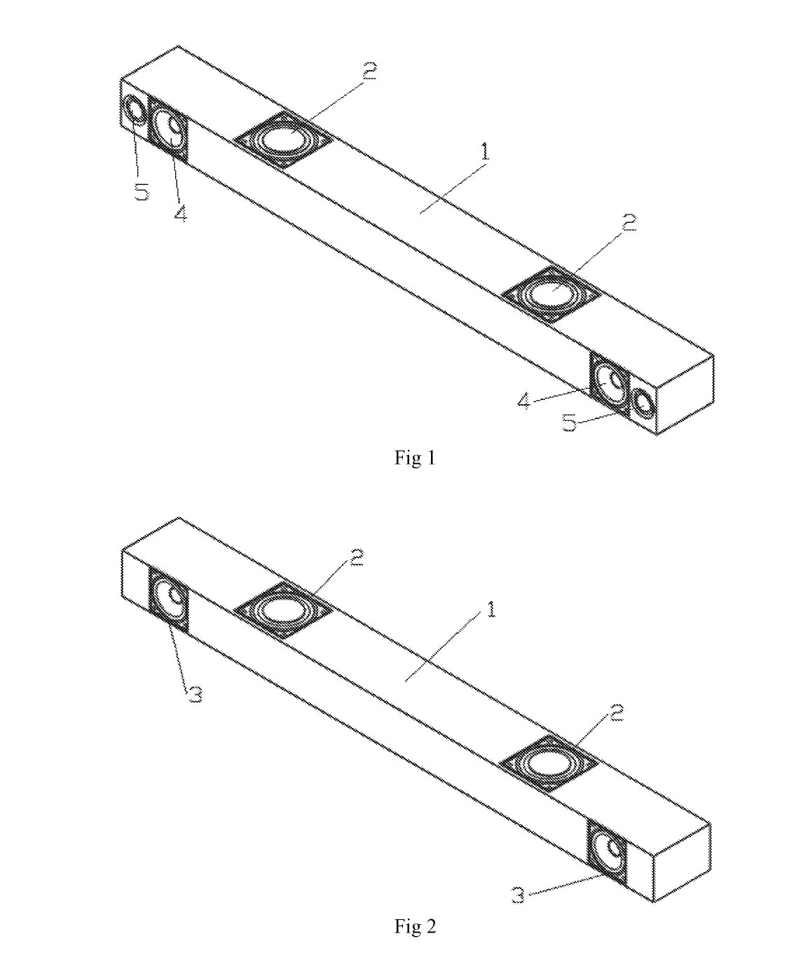

In some embodiment of the present disclosure, referring to FIG. 1, the loudspeaker comprises: a loudspeaker main body 1, a low frequency speaker unit 2, a medium frequency speaker unit 4 and a high frequency speaker unit 5. Those skilled in the art may appreciate that a control device is disposed in the loudspeaker main body 1, the low frequency speaker unit 2, the medium frequency speaker unit 4 and the high frequency speaker unit 5 are respectively connected with the control device to implement control of respective speaker units, including control of sound channel changes and volume and the like. The loudspeaker main body 1 is provided with a first surface and a second surface which are perpendicular to each other. The low frequency speaker unit 2 is provided on the first surface, and the medium frequency speaker unit 4 and the high frequency speaker unit 5 are disposed on the second surface.

Usually, the high frequency speaker unit 5 functions to output, from a frequency divider, a high-frequency signal with a frequency range of 3 KHz-10 KHz generally to express fineness of sound. The high frequency speaker unit 5 may be designed in a small size. A frequency range of the medium frequency speaker unit is 200-3 KHz. A sound with a frequency of 200-500 Hz sounds powerful; a sound with a frequency of 500-1000 Hz sounds bright; a sound with a frequency of 1000-3000 Hz sounds transparent. The medium frequency speaker unit 4 may be designed in a small size. A frequency range of the low frequency speaker unit 2 is 16-200 Hz, wherein a sound with a frequency of 16-64 Hz sounds deep and shocking; a sound with a frequency of 64-120 Hz sounds thick, and a sound with a frequency of 120-200 Hz sounds rich. The low frequency speaker unit 2 is generally used in cooperation with the high frequency speaker unit 5 and the medium frequency speaker unit 4. Upon use, the low frequency speaker unit 2 is not limited in direction and may be disposed in any direction. However, the medium frequency speaker unit 4 and the high frequency speaker unit 5 are limited in direction upon use, and they need to face towards the user so as to provide the user with an excellent auditory enjoyment.

To facilitate manufacture, the loudspeaker main body 1 is designed as a cuboid, and the low frequency speaker unit 2 is disposed on the upper surface of the cuboid in a long-side direction. Upon use, the long side of the loudspeaker is placed horizontally. Certainly, the shape of the loudspeaker main body 1 may be designed in other shapes according to needs, such as cylinder, prism, semi-cylinder, or tetrahedron. The present disclosure does not limit this. The cuboid has sides in length direction, width direction and height direction, and has a front surface, a rear surface, an upper surface, a lower surface, a left surface and a right surface. The front surface faces towards the user. Since the medium frequency speaker unit 4 and high frequency speaker unit 5 are limited in direction upon use, the medium frequency speaker unit 4 and high frequency speaker unit 5 are disposed on the front surface. The low frequency speaker unit 2 is not limited in direction, so it is disposed on the upper surface so that the low frequency speaker unit 2 may not occupy space of the loudspeaker in the height direction. This may make the loudspeaker lighter and thinner and enhance the stereo sound effect of the loudspeaker.

A plurality of medium frequency speaker units 4 and a plurality of high frequency speaker units 5 are disposed to achieve a better sound effect. Furthermore, referring to FIG. 1, to meet the light-weighted and thinner requirements, there are two high frequency speaker units which are symmetrically disposed at both ends of the front surface in the long-side direction. There are two medium frequency speaker units 4 which are symmetrically disposed at positions on the front surface in the long-side direction and are located inside the high frequency speaker unit 5. Correspondingly, there are two low frequency speaker units 2 which are symmetrically disposed at positions on the upper surface in the long-side direction. A distance between the two low frequency speaker units 2 is smaller than that between the two medium frequency speaker units 4. The symmetrical arrangement manner enables one end of the loudspeaker 1 to be a left sound channel of the loudspeaker, and the other end to be a right sound channel of the loudspeaker. As such, a better sound effect may be presented. Certainly, the number of speaker units is not limited to two, and their positions may be set according to actual needs.

Certainly, the medium frequency speaker unit 4 and high frequency speaker unit 5 may be disposed on the upper surface depending on the difference of use environments. The low frequency speaker unit 2 is disposed on the front surface such that the low frequency speaker unit 2 may not occupy the space of the loudspeaker in the width direction and may make the loudspeaker lighter and thinner.

In another embodiment of the present disclosure, referring to FIG. 2, the loudspeaker main body 1 is a cuboid, and the low frequency speaker unit 2 is disposed on the upper surface of the cuboid in a long-side direction. Certainly, the shape of the loudspeaker main body 1 may be designed in other shapes according to needs, such as cylinder, prism, semi-cylinder, or tetrahedron. The present disclosure does not limit this. The cuboid has sides in length direction, width direction and height direction, and has a front surface, a rear surface, an upper surface, a lower surface, a left surface and a right surface. The second speaker unit is a full frequency speaker unit 3. The full frequency speaker unit 3 is limited in direction upon use. There are a plurality of full frequency speaker units 3 which are disposed on the front surface of the loudspeaker main body 1. The full frequency speaker unit 3 has a frequency range of 200 Hz-10 KHz and may present different sound effects. To meet light-weighted and thinner requirements, the full frequency speaker unit 3 may also be made miniature. A plurality of full frequency speaker units 3 may be arranged to achieve a better sound effect. Furthermore, there are two full frequency speaker units 3 which are symmetrically disposed on the front surface in the long-side direction. Correspondingly, there are two low frequency speaker units 2 which are symmetrically disposed at positions on the upper surface in the long-side direction. Furthermore, a distance between the two low frequency speaker units 2 is smaller than that between the two full frequency speaker units 3. The symmetrical arrangement manner enables one end of the loudspeaker 1 to be a left sound channel of the loudspeaker, and the other end to be a right sound channel of the loudspeaker. As such, a better sound effect may be presented. Certainly, the number of speaker units is not limited to two, and their positions may be set according to actual needs.

In the loudspeaker according to an embodiment of the present disclosure, the medium frequency speaker unit 4 and high frequency speaker unit 5 that may be made miniature are disposed on the second surface, and the low frequency speaker unit 2 that cannot be made miniature is disposed on the first surface. Alternatively, the full frequency speaker unit 3 that may be made miniature is disposed on the second surface, and the low frequency speaker unit 2 that cannot be made miniature is disposed on the first surface. The first surface is perpendicular to the second surface, the low frequency speaker unit 2 does not occupy the space of the second surface in the height direction, may effectively reduce the height of the loudspeaker and make the loudspeaker lighter and thinner. Upon use, the loudspeaker does not shield the TV remote control receiver and TV images and increases the user's experience. Furthermore, the stereo sound effect of the loudspeaker may be enhanced.

Certainly, the full frequency speaker unit 3 may be disposed on the upper surface depending on the difference of the use environments. The low frequency speaker unit 2 is disposed on the front surface such that the low frequency speaker unit 2 may not occupy the space of the loudspeaker in the width direction and may make the loudspeaker lighter and thinner.

Although some specific embodiments of the present disclosure have already been described in detail by way of examples, those skilled in the art should appreciate that the above examples are only for illustrative purpose and not intended to limit the scope of the present disclosure. Those skilled in the art should appreciate that modifications may be made to the above embodiments without departing from the scope and spirit of the present disclosure. The scope of the present disclosure is defined by the appended claims.

What is claimed is:

1. A loudspeaker, comprising a loudspeaker main body;
wherein the loudspeaker main body is provided with a first surface and a second surface which are perpendicular to each other;
the first surface is provided with a first speaker unit;
the second surface is provided with a second speaker unit.

2. The loudspeaker according to claim 1, wherein the first speaker unit is a low frequency speaker unit, and the second speaker unit comprises a medium frequency speaker unit and a high frequency speaker unit, or the second speaker unit comprises a full frequency speaker unit.

3. The loudspeaker according to claim 2, wherein the loudspeaker main body is a cuboid.

4. The loudspeaker according to claim 3, wherein the low frequency speaker unit is disposed on an upper surface of the cuboid in a long-side direction.

5. The loudspeaker according to claim 4, wherein the second speaker unit is disposed on a front surface of the loudspeaker main body; the second speaker unit comprises a medium frequency speaker unit and a high frequency speaker unit, and there are a plurality of medium frequency speaker units and a plurality of high frequency speaker units.

6. The loudspeaker according to claim 5, wherein there are two high frequency speaker units which are symmetrically disposed at both ends of the front surface in the long-side direction; there are two medium frequency speaker units which are symmetrically disposed at positions on the front surface in the long-side direction and are located inside the high frequency speaker units.

7. The loudspeaker according to claim 6, wherein there are two low frequency speaker units which are symmetrically disposed at positions on the upper surface in the long-side direction, and a distance between the two low frequency speaker units is smaller than that between the two medium frequency speaker units.

8. The loudspeaker according to claim 4, wherein the second speaker unit is disposed on the front surface of the loudspeaker main body; the second speaker unit is a full frequency speaker unit, and there are a plurality of full frequency speaker units.

9. The loudspeaker according to claim 8, wherein there are two full frequency speaker units which are symmetrically disposed at positions on the front surface in the long-side direction.

10. The loudspeaker according to claim 9, wherein there are two low frequency speaker units which are symmetrically disposed at positions on the upper surface in the long-side direction, and a distance between the two low frequency speaker units is smaller than that between the two full frequency speaker units.
